(19) United States
(12) Patent Application Publication
(10) Pub. No.: US 2025/0236732 A1
(43) Pub. Date: Jul. 24, 2025

(54) THERMALLY CONDUCTIVE COMPOSITION

(71) Applicant: INDUSTRIAL TECHNOLOGY RESEARCH INSTITUTE, Hsinchu (TW)

(72) Inventors: Hsiang-Yen TSAO, Zhubei City (TW); Hui-Wen CHANG, Hsinchu City (TW); Hsi-Yi CHIN, Hsinchu City (TW); Ting-Wei LAI, Tainan City (TW); Jyh-Long JENG, New Taipei City (TW)

(73) Assignee: INDUSTRIAL TECHNOLOGY RESEARCH INSTITUTE, Hsinchu (TW)

(21) Appl. No.: 18/734,415

(22) Filed: Jun. 5, 2024

(30) Foreign Application Priority Data
Jan. 18, 2024 (TW) 113101967

(51) Int. Cl. C08L 79/08; C08K 3/28; C08K 5/5419

(52) U.S. Cl. CPC C08L 79/08; C08K 3/28; C08K 5/5419; C08K 2003/282; C08K 2201/001; C08K 2201/005; C08L 2203/20; C08L 2205/03; C08L 2205/05; C08L 2312/04

(57) ABSTRACT

A thermally conductive composition includes (A) polyamide-imide, (B) epoxy resin, (C) curing agent, (D) filler, and (E) benzene-containing silane, in which (A) polyamide-imide has a chemical structure of

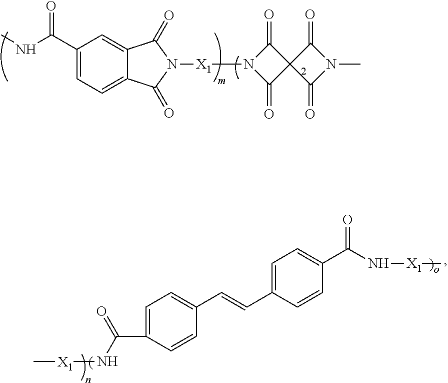

wherein X₁ is

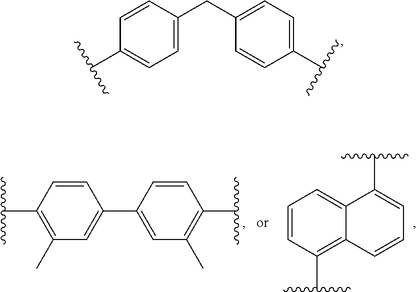 [SMILES: *c1ccc(Cc2ccc(*)cc2)cc1 ; *c1ccc(-c2ccc(*)c(C)c2)cc1C ; *c1cccc2c(*)cccc12]

X₂

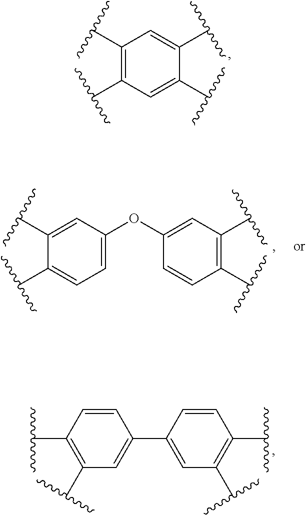 [SMILES: *c1cc(*)c(*)cc1* ; *c1ccc(Oc2ccc(*)c(*)c2)cc1* ; *c1ccc(-c2ccc(*)c(*)c2)cc1*]

m=60 to 80, n=10 to 30, and o=10 to 30.

### CROSS REFERENCE TO RELATED APPLICATIONS

The present application is based on, and claims priority from, Taiwan Application Serial Number 113101967, filed on Jan. 18, 2024, the disclosure of which is hereby incorporated by reference herein in its entirety.

### TECHNICAL FIELD

The technical field relates to a thermally conductive composition.

### BACKGROUND

In recent years, various electronic products have continuously been developed to be more lightweight, smaller in size, and have a thinner profile and higher performance. However, chips with higher power and narrower spaces increase the heat generation per unit volume in the element. Therefore, an insulating film with high thermal conductivity is required to tightly adhere to the chip to transfer heat out for heat dissipation. In addition, as compound semiconductor technology gradually matures, demands for compound semiconductors are beginning to increase in application fields such as electric vehicles, large wind power plants, and mobile base stations. Because these compound semiconductors have high operating temperatures and can withstand high voltage and current, the base material in the insulating film must have improved properties such as high temperature resistance and high voltage resistance in order to have the electronic components to function efficiently. In addition, the thinning of insulating films is also a critical issue, which not only reduces the size of components but also reduces thermal resistance for dissipating heat more efficiently.

Accordingly, a novel thermally conductive composition having a high breakdown voltage, peel strength, thermal conductivity, and film formability to meet the requirement for the electronic elements is called for.

### SUMMARY

One embodiment of the disclosure provides a thermally conductive composition, including (A) polyamide-imide, (B) epoxy resin, (C) curing agent, (D) filler, and (E) benzene-containing silane, wherein (A) polyamide-imide has a chemical structure of

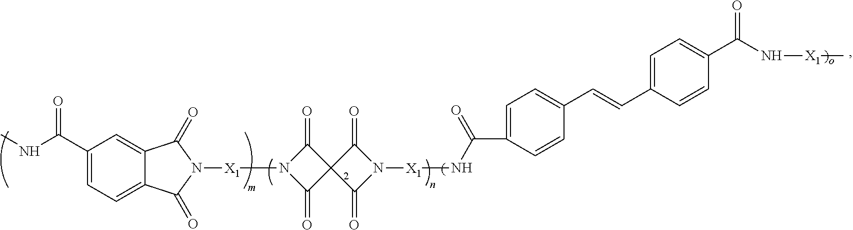

wherein X₁ is

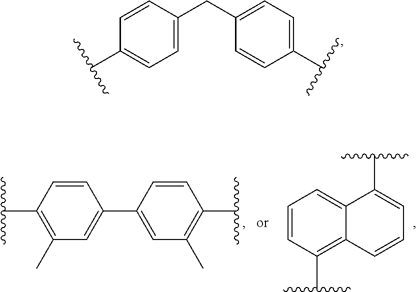 [SMILES: *c1ccc(Cc2ccc(*)cc2)cc1 ; *c1ccc(-c2ccc(*)c(C)c2)cc1C ; *c1cccc2c(*)cccc12]

### X₂ is

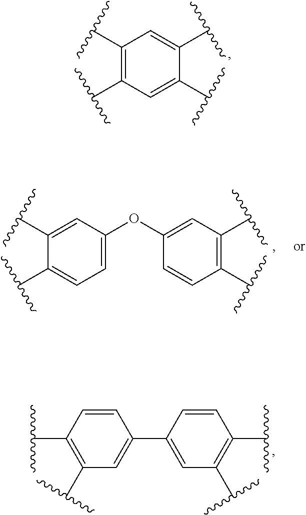 [SMILES: *c1cc(*)c(*)cc1* ; *c1ccc(Oc2ccc(*)c(*)c2)cc1* ; *c1ccc(-c2ccc(*)c(*)c2)cc1*]

m=60 to 80, n=10 to 30, and o=10 to 30.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a thermally conductive composition, including (A) polyamide-imide, (B) epoxy resin, (C) curing agent, (D) filler, and (E) benzene-containing silane, wherein (A) polyamide-imide has a chemical structure of

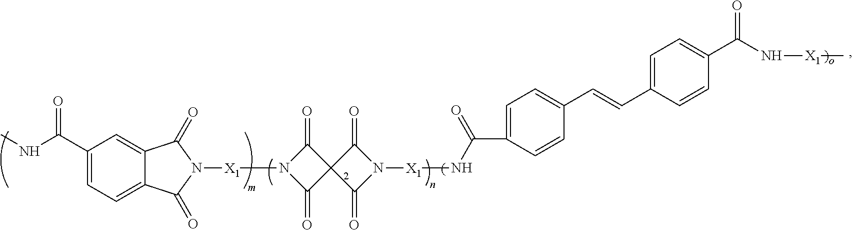

wherein X₁ is

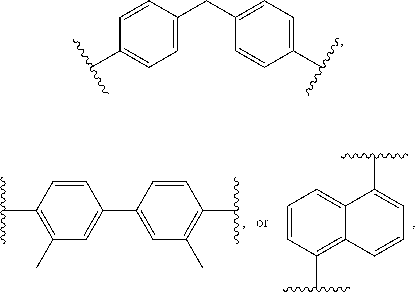 [SMILES: *c1ccc(Cc2ccc(*)cc2)cc1 ; *c1ccc(-c2ccc(*)c(C)c2)cc1C ; *c1cccc2c(*)cccc12]

### X₂ is

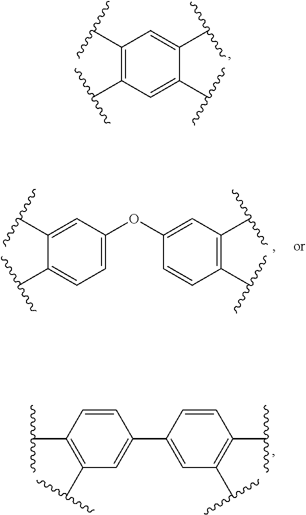 [SMILES: *c1cc(*)c(*)cc1* ; *c1ccc(Oc2ccc(*)c(*)c2)cc1* ; *c1ccc(-c2ccc(*)c(*)c2)cc1*]

m=60 to 80, n=10 to 30, and o=10 to 30. If X₁ or X₂ is another arylene group, the thermally conductive composition will have an insufficient thermal conductivity. If a value of m, n, or o is too high or too low, the peel strength and the thermal conductivity of the thermally conductive composition will be too low.

In some embodiments, a weight of (A) polyamide-imide and a total weight of (B) epoxy resin and (C) curing agent have a ratio of 6:4 to 7:3. If the amount of (A) polyamide-imide is too low, the breakdown voltage of a film that is formed from the thermally conductive composition will be too low. If the amount of (A) polyamide-imide is too high, the peel strength and the thermal conductivity of the film that is formed from the thermally conductive composition will be too low.

In some embodiments, (B) epoxy resin and (C) curing agent have a weight ratio of 1:0.5 to 1:1.1. If the amount of (B) epoxy resin is too high or too low, the thermally conductive composition will have insufficient film formability (e.g. crack) and the thermal conductivity that is too low.

In some embodiments, the thermally conductive composition and (D) filler have a weight ratio of 100:84 to 100:89. If the amount of (D) filler is too low, the thermal conductivity of the film that is formed from the thermally conductive composition will be insufficient. If the amount of (D) filler is too high, the thermally conductive composition will have insufficient film formability (e.g. crack).

In some embodiments, (D) filler and (E) benzene-containing silane have a weight ratio of 100:1 to 100:2.3. (E) benzene-containing silane is a modifier, which may modify the surface of (D) filler, such that the modified (D) filler can be compatible with the other compositions. If the amount of (E) benzene-containing silane is too low, (D) filler will aggregate and cannot be efficiently dispersed in the thermally conductive composition. If the amount of (E) benzene-containing silane is too high, the filler will self-aggregate, such that the film surface will be poor or the film formability will be insufficient.

In some embodiments, (B) epoxy resin includes 4,4′-bis(2,3-epoxypropoxy)-3,3′,5,5′-tetramethylbiphenyl, hydrogenated bisphenol A resin, 1,4-cyclohexanedimethanol diglycidyl ether, or a combination thereof. In some embodiments, (C) curing agent comprises triphenylmethane-type phenolic resin, xylene-modified phenolic resin, biphenyl-type phenolic resin, or a combination thereof.

In some embodiments, (D) filler includes aluminum nitride filler. For example, the aluminum nitride filler includes (D1) aluminum nitride filler having a diameter of 1 micrometer to 3 micrometers, (D2) aluminum nitride filler having a diameter of 5 micrometers to 15 micrometers, and (D3) aluminum nitride filler having a diameter of 20 micrometers to 30 micrometers. In some embodiments, (D1) aluminum nitride filler having a diameter of 1 micrometer to 3 micrometers, (D2) aluminum nitride filler having a diameter of 5 micrometers to 15 micrometers, and (D3) aluminum nitride filler having a diameter of 20 micrometers to 30 micrometers have a weight ratio of 50˜70:5˜10:20˜45. If the amount of (D1) aluminum nitride filler having a diameter of 1 micrometer to 3 micrometers, (D2) aluminum nitride filler having a diameter of 5 micrometers to 15 micrometers, or (D3) aluminum nitride filler having a diameter of 20 micrometers to 30 micrometers is too low or too high, the breakdown voltage and the thermal conductivity of the film formed from the thermally conductive composition will be too low.

In some embodiments, (E) benzene-containing silane includes trimethoxyphenylsilane, trimethoxy(2-phenylethyl)silane, or a combination thereof. If another silane such as epoxy-containing silane is adopted as a modifier, the breakdown voltage, peel strength, and thermal conductivity of the film that is formed from the thermally conductive composition will be insufficient.

Accordingly, the thermally conductive composition of the disclosure has specific compositions of specific ratios, and the film formed from the composition has excellent breakdown voltage (electrical insulation), peel strength, thermal conductivity, and film formability. As such, the thermally conductive composition is suitable to adhere to electronic components for achieving the required heat dissipation function, thereby improving the performance of the electronic device.

Below, exemplary embodiments will be described in detail to be easily realized by a person having ordinary knowledge of the art. The inventive concept may be embodied in various forms without being limited to the exemplary embodiments set forth herein.

### EXAMPLES

In following Examples, 4,4′-bis(2,3-epoxypropoxy)-3,3′,5, 5′-tetramethylbiphenyl (YX4000, commercially available from Mitsubishi Chemical), hydrogenated bisphenol A resin (YX8000, commercially available from Mitsubishi Chemical), and 1,4-cyclohexanedimethanol diglycidyl ether (CDMDG, commercially available from Showa Denko) were adopted as (B) epoxy resin. Triphenylmethane-type phenolic resin MEH-7500 (commercially available from Meiwa Plastic Industries, Ltd.), biphenyl-type phenolic resin MEHC-7841-4S (commercially available from Meiwa Plastic Industries, Ltd.), and xylene-modified phenolic resin PF8090M62 (commercially available from Chang Chun Petrochemical Co., Ltd) were adopted as (C) curing agent. Aluminum nitride filler having a diameter of 25 micrometers (AlN250RW, commercially available from Thrutek Applied Materials Co., Ltd.), aluminum nitride filler having a diameter of 10 micrometers (AlN100NW, commercially available from Thrutek Applied Materials Co., Ltd.), and aluminum nitride filler having a diameter of 2 micrometers (AlNO20NW, commercially available from Thrutek Applied Materials Co., Ltd.) were adopted as (D) filler. Trimethoxyphenylsilane (AP-S8010, commercially available from An Fong Development Co., Ltd.) and trimethoxy(2-phenylethyl)silane (SIP6722.6, commercially available from Gelest) were adopted as (E) benzene-containing silane. 3-[(Glycidyloxy)propyl]dimethylethoxysilane (KBM-403, commercially available from Shin-Etsu Chemical Co., Ltd.) was adopted as epoxy-containing silane.

In following Examples, the thickness of a film formed from the thermally conductive composition was measured by a micrometer gauge. The breakdown voltage of the film was measured according to the standard ASTM D149. The peel strength of the film was measured according to the standard IPC-TM650 (2.4.9E). The thermal conductivity of the film was measured according to the standard ASTM E1461. The film formability was visually judged by observing the outer appearance of the film to examine whether it was cracked or filler aggregation phenomena (e.g. spot or the like) existed.

### Synthesis Example 1

250.25 g of 4,4′-methylene diphenyl diisocyanate (MDI, 1 part by mole), 115.26 g of trimellitic anhydride (TMA, 0.6 parts by mole), 26.83 g of 4,4′-stilbenedicarboxylic acid (StDA, 0.1 parts by mole), and 88.26 g of 3,3′,4,4′-biphenyl tetracarboxylic dianhydride (BPDA, 0.3 parts by mole) were added to 1121.39 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining polyamide-imide (PAI) resin A solution (m:n:o=60:30:10).

### Synthesis Example 2

250.25 g of MDI (1 part by mole), 115.26 g of TMA (0.6 parts by mole), 53.65 g of StDA (0.2 parts by mole), and 58.84 g of BPDA (0.2 parts by mole) were added to 1115.34 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin B solution (m:n:o=60:20:20).

### Synthesis Example 3

250.25 g of MDI (1 part by mole), 115.26 g of TMA (0.6 parts by mole), 80.48 g of StDA (0.3 parts by mole), and 29.42 g of BPDA (0.1 parts by mole) were added to 1109.29 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin C solution (m:n:o=60:10:30).

### Synthesis Example 4

200.2 g of MDI (0.8 parts by mole), 52.86 g of 3,3′-dimethylbiphenyl-4,4′-diisocyanate (TODI, 0.2 parts by mole), 115.26 g of TMA (0.6 parts by mole), 53.65 g of StDA (0.2 parts by mole), and 58.84 g of BPDA (0.2 parts by mole) were added to 1121.89 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin D solution (m:n:o=60:20:20).

### Synthesis Example 5

200.2 g of MDI (0.8 parts by mole), 42.04 g of 1,5-naphthalene diisocyanate (NDI, 0.2 parts by mole), 115.26 g of TMA (0.6 parts by mole), 53.65 g of StDA (0.2 parts by mole), and 58.84 g of BPDA (0.2 parts by mole) were added to 1096.64 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin E solution (m:n:o=60:20:20).

### Synthesis Example 6

250.25 g of MDI (1 part by mole), 115.26 g of TMA (0.6 parts by mole), 53.65 g of StDA (0.2 parts by mole), and 43.62 g of pyromellitic dianhydride (PMDA, 0.2 parts by mole) were added to 1079.83 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin F solution (m:n:o=60:20:20).

### Synthesis Example 7

250.25 g of MDI (1 part by mole), 115.26 g of TMA (0.6 parts by mole), 53.65 g of StDA (0.2 parts by mole), and 62.04 g of 4,4′-oxydiphthalic anhydride (OPDA, 0.2 parts by mole) were added to 1122.81 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin G solution (m:n:o=60:20:20).

### Synthesis Example 8

250.25 g of MDI (1 part by mole), 115.26 g of TMA (0.6 parts by mole), 53.65 g of StDA (0.2 parts by mole), and 104.10 g of 4,4′-bisphenol A Dianhydride (BPADA, 0.2 parts by mole) were added to 1220.94 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin H solution (m:n:o=60:20:20).

### Synthesis Example 9

250.25 g of MDI (1 part by mole) and 192.10 g of TMA (1 part by mole) were added to 1032.15 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin I solution (m:n:o=100:0:0).

### Synthesis Example 10

250.25 g of MDI (1 part by mole), 153.68 g of TMA (0.8 parts by mole), 26.83 g of StDA (0.1 parts by mole), and 29.42 g of BPDA (0.1 parts by mole) were added to 1073.74 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin J solution (m:n:o=80:10:10).

### Synthesis Example 11

250.25 g of MDI (1 part by mole), 96.05 g of TMA (0.5 parts by mole), 53.65 g of StDA (0.2 parts by mole), and 88.26 g of BPDA (0.3 parts by mole) were added to 1113.92 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin K solution (m:n:o=50:30:20).

### Synthesis Example 12

250.25 g of MDI (1 part by mole), 144.08 g of TMA (0.75 parts by mole), 53.65 g of StDA (0.2 parts by mole), and 14.71 g of BPDA (0.05 parts by mole) were added to 1079.60 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin L solution (m:n:o=75:5:20).

### Synthesis Example 13

250.25 g of MDI (1 part by mole), 76.84 g of TMA (0.4 parts by mole), 80.48 g of StDA (0.3 parts by mole), and 88.26 g of BPDA (0.3 parts by mole) were added to 1156.93 g of NMP solvent to be dissolved and uniformly stirred. The solution was heated to 80° C. to react for 1 hour, then heated to 120° C. to react for 2 hours, and then heated to 170° C. to react for 2 hours. The reaction result was cooled down to room temperature, thereby obtaining PAI resin M solution (m:n:o=40:30:30).

### Example 1

100 g of PAI resin A solution (solid content of 30%) from Synthesis Example 1, 4.63 g of the epoxy resin YX4000, 3.38 g of the epoxy resin CDMDG, 4.85 g of the curing agent MEH-7500, 200.77 g of the aluminum nitride filler AlN250RW, 28.68 g of the aluminum nitride filler AlN100NW, 57.36 g of the aluminum nitride filler AlN020NW, and 2.96 g of the benzene-containing silane AP-S8010 were mixed to form a film having a thickness of 78 micrometers, a breakdown voltage of 3.1 kV, a peel strength of 5.3 N/cm, a thermal conductivity of 5.3 W/m*K, and excellent film formability. In the film, PAI resin: (epoxy resin+curing agent)=7:3 (weight ratio). The film had 86.2 wt % of aluminum nitride filler.

### Example 2

100 g of PAI resin A solution (solid content of 30%) from Synthesis Example 1, 4.63 g of the epoxy resin YX4000, 3.38 g of the epoxy resin CDMDG, 4.85 g of the curing agent MEH-7500, 172.09 g of the aluminum nitride filler AlN250RW, 28.68 g of the aluminum nitride filler AlN100NW, 86.04 g of the aluminum nitride filler AlN020NW, and 2.96 g of the benzene-containing silane AP-S8010 were mixed to form a film having a thickness of 75 micrometers, a breakdown voltage of 3.5 kV, a peel strength of 5.3 N/cm, a thermal conductivity of 5.2 W/m*K, and excellent film formability. In the film, PAI resin: (epoxy resin+curing agent)=7:3 (weight ratio). The film had 86.2 wt % of aluminum nitride filler.

### Example 3

100 g of PAI resin A solution (solid content of 30%) from Synthesis Example 1, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 70 micrometers, a breakdown voltage of 3.7 kV, a peel strength of 5.4 N/cm, a thermal conductivity of 5.5 W/m*K, and excellent film formability. In the film, PAI resin: (epoxy resin+curing agent)=7:3 (weight ratio). The film had 86.2 wt % of aluminum nitride filler.

### Comparative Example 1

100 g of PAI resin A solution (solid content of 30%) from Synthesis Example 1, 4.63 g of the epoxy resin YX4000, 3.38 g of the epoxy resin CDMDG, 4.85 g of the curing agent MEH-7500, 229.45 g of the aluminum nitride filler AlN250RW, 14.34 g of the aluminum nitride filler AlN100NW, 43.02 g of the aluminum nitride filler AlN020NW, and 2.96 g of the benzene-containing silane AP-S8010 were mixed to form a film having a thickness of 89 micrometers, a breakdown voltage of 2.0 kV, a peel strength of 5.3 N/cm, a thermal conductivity of 4.2 W/m*K, and excellent film formability. In the film, PAI resin: (epoxy resin+curing agent)=7:3 (weight ratio). The film had 86.2 wt % of aluminum nitride filler. As shown in Comparative Example 1, too much amount of the aluminum nitride filler AlN250RW and too little amount of the aluminum nitride filler AlN020NW would decrease the breakdown voltage and the thermal conductivity of the film.

### Comparative Example 2

100 g of PAI resin A solution (solid content of 30%) from Synthesis Example 1, 4.63 g of the epoxy resin YX4000, 3.38 g of the epoxy resin CDMDG, 4.85 g of the curing agent MEH-7500, 114.73 g of the aluminum nitride filler AlN250RW, 172.09 g of the aluminum nitride filler AlNO20NW, and 2.96 g of the benzene-containing silane AP-S8010 were mixed to form a film having a thickness of 64 micrometers, a breakdown voltage of 2.3 kV, a peel strength of 5.5 N/cm, a thermal conductivity of 4.2 W/m*K, and excellent film formability. In the film, PAI resin: (epoxy resin+curing agent)=7:3 (weight ratio). The film had 86.2 wt % of aluminum nitride filler. As shown in Comparative Example 2, too little amount of the aluminum nitride filler AlN250RW, free of the aluminum nitride filler AlN100NW, and too much amount of the aluminum nitride filler AlN020NW would decrease the breakdown voltage and the thermal conductivity of the film.

### Example 4

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 73 micrometers, a breakdown voltage of 3.4 kV, a peel strength of 5.2 N/cm, a thermal conductivity of 5.3 W/m*K, and excellent film formability. In the film, PAI resin: (epoxy resin+curing agent)=7:3 (weight ratio). The film had 86.2 wt % of aluminum nitride filler.

### Example 5

100 g of PAI resin C solution (solid content of 30%) from Synthesis Example 3, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 75 micrometers, a breakdown voltage of 3.3 kV, a peel strength of 5.3 N/cm, a thermal conductivity of 5.5 W/m*K, and excellent film formability. In the film, PAI resin: (epoxy resin+curing agent)=7:3 (weight ratio). The film had 86.2 wt % of aluminum nitride filler.

### Example 6

100 g of PAI resin J solution (solid content of 30%) from Synthesis Example 10, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 75 micrometers, a breakdown voltage of 3.3 kV, a peel strength of 5.1 N/cm, a thermal conductivity of 5.1 W/m*K, and excellent film formability. In the film, PAI resin: (epoxy resin+curing agent)=7:3 (weight ratio). The film had 86.2 wt % of aluminum nitride filler.

### Comparative Example 3

100 g of PAI resin I solution (solid content of 30%) from Synthesis Example 9, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 75 micrometers, a breakdown voltage of 3.2 kV, a peel strength of 5.3 N/cm, a thermal conductivity of 3.8 W/m*K, and excellent film formability. In the film, PAI resin: (epoxy resin+curing agent)=7:3 (weight ratio). The film had 86.2 wt % of aluminum nitride filler. As shown in Comparative Example 3, when the PAI resin I was free of StDA, the thermal conductivity of the film would be decreased.

### Comparative Example 4

100 g of PAI resin K solution (solid content of 30%) from Synthesis Example 11, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed, which had a poor film formability (crack). In the mixture, PAI resin: (epoxy resin+curing agent)=7:3 (weight ratio). The mixture had 86.2 wt % of aluminum nitride filler. As shown in Comparative Example 4, when the m value of PAI resin was too low, the thermally conductive composition would crack and could not be used to form a film.

### Example 7

100 g of PAI resin D solution (solid content of 30%) from Synthesis Example 4, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 72 micrometers, a breakdown voltage of 3.1 kV, a peel strength of 5.3 N/cm, a thermal conductivity of 5.2 W/m*K, and excellent film formability. In the film, PAI resin: (epoxy resin+curing agent)=7:3 (weight ratio). The film had 86.2 wt % of aluminum nitride filler.

### Example 8

100 g of PAI resin E solution (solid content of 30%) from Synthesis Example 5, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 70 micrometers, a breakdown voltage of 3.2 kV, a peel strength of 5.1 N/cm, a thermal conductivity of 5.1 W/m*K, and excellent film formability. In the film, PAI resin: (epoxy resin+curing agent)=7:3 (weight ratio). The film had 86.2 wt % of aluminum nitride filler.

### Example 9

100 g of PAI resin F solution (solid content of 30%) from Synthesis Example 6, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 70 micrometers, a breakdown voltage of 3.2 kV, a peel strength of 5.2 N/cm, a thermal conductivity of 5.2 W/m*K, and excellent film formability. In the film, PAI resin: (epoxy resin+curing agent)=7:3 (weight ratio). The film had 86.2 wt % of aluminum nitride filler.

### Example 10

100 g of PAI resin G solution (solid content of 30%) from Synthesis Example 7, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 73 micrometers, a breakdown voltage of 3.2 kV, a peel strength of 5.3 N/cm, a thermal conductivity of 5.3 W/m*K, and excellent film formability. In the film, PAI resin: (epoxy resin+curing agent)=7:3 (weight ratio). The film had 86.2 wt % of aluminum nitride filler.

### Comparative Example 5

100 g of PAI resin H solution (solid content of 30%) from Synthesis Example 8, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 75 micrometers, a breakdown voltage of 2.8 kV, a peel strength of 5.3 N/cm, a thermal conductivity of 3.4 W/m*K, and excellent film formability. In the film, PAI resin: (epoxy resin+curing agent)=7:3 (weight ratio). The film had 86.2 wt % of aluminum nitride filler. As shown in Comparative Example 5, when BPADA was adopted to form PAI resin H, the thermal conductivity of the film was too low.

### Example 11

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 3.38 g of the benzene-containing silane SIP6722.6 were mixed to form a film having a thickness of 71 micrometers, a breakdown voltage of 3.3 kV, a peel strength of 5.1 N/cm, a thermal conductivity of 5.5 W/m*K, and excellent film formability. In the film, PAI resin: (epoxy resin+curing agent)=7:3 (weight ratio). The film had 86.2 wt % of aluminum nitride filler.

### Comparative Example 6

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 3.52 g of the epoxy-containing silane KBM-403 were mixed to form a film having a thickness of 71 micrometers, a breakdown voltage of 1.7 kV, a peel strength of 3.8 N/cm, a thermal conductivity of 3.4 W/m*K, and excellent film formability. In the film, PAI resin: (epoxy resin+curing agent)=7:3 (weight ratio). The film had 86.2 wt % of aluminum nitride filler. As shown in Comparative Example 6, when the epoxy-containing silane rather than the benzene-containing silane was adopted as the modifier, the breakdown voltage, the peel strength, and the thermal conductivity of the film were too low.

### Example 12

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 121.43 g of the aluminum nitride filler AlN250RW, 12.14 g of the aluminum nitride filler AlN100NW, 109.29 g of the aluminum nitride filler AlN020NW, and 2.50 g of the benzene-containing silane AP-S8010 were mixed to form a film having a thickness of 72 micrometers, a breakdown voltage of 3.4 kV, a peel strength of 5.4 N/cm, a thermal conductivity of 5.3 W/m*K, and excellent film formability. In the film, PAI resin: (epoxy resin+curing agent)=7:3 (weight ratio). The film had 84.3 wt % of aluminum nitride filler.

### Example 13

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 173.38 g of the aluminum nitride filler AlN250RW, 17.34 g of the aluminum nitride filler AlN100NW, 156.04 g of the aluminum nitride filler AlNO20NW, and 3.58 g of the benzene-containing silane AP-S8010 were mixed to form a film having a thickness of 72 micrometers, a breakdown voltage of 3.5 kV, a peel strength of 5.2 N/cm, a thermal conductivity of 5.2 W/m*K, and an excellent film formability. In the film, PAI resin: (epoxy resin+curing agent)=7:3 (weight ratio). The film had 88.2 wt % of aluminum nitride filler.

### Comparative Example 7

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 112.50 g of the aluminum nitride filler AlN250RW, 11.25 g of the aluminum nitride filler AlN100NW, 101.25 g of the aluminum nitride filler AlN020NW, and 2.32 g of the benzene-containing silane AP-S8010 were mixed to form a film having a thickness of 73 micrometers, a breakdown voltage of 3.8 kV, a peel strength of 5.4 N/cm, a thermal conductivity of 3.9 W/m*K, and excellent film formability. In the film, PAI resin: (epoxy resin+curing agent)=7:3 (weight ratio). The film had 83.3 wt % of aluminum nitride filler. As shown in Comparative Example 7, when the amount of the aluminum nitride filler was too low, the thermal conductivity of the film would decrease.

### Comparative Example 8

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 216.67 g of the aluminum nitride filler AlN250RW, 21.67 g of the aluminum nitride filler AlN100NW, 195 g of the aluminum nitride filler AlN020NW, and 4.47 g of the benzene-containing silane AP-S8010 were mixed to form a mixture having a poor film formability (e.g. crack). In the mixture, PAI resin: (epoxy resin+curing agent)=7:3 (weight ratio). The mixture had 90 wt % of aluminum nitride filler. As shown in Comparative Example 8, when the amount of the aluminum nitride filler was too high, the thermally conductive composition could not be used to form a film.

### Example 14

100 g of PAI resin B solution (solid content of 30%) from Synthesis Example 2, 7.20 g of the epoxy resin YX4000, 5.26 g of the epoxy resin CDMDG, 7.54 g of the curing agent MEH-7500, 167.31 g of the aluminum nitride filler AlN250RW, 16.73 g of the aluminum nitride filler AlN100NW, 150.58 g of the aluminum nitride filler AlNO20NW, and 3.45 g of the benzene-containing silane AP-S8010 were mixed to form a film having a thickness of 70 micrometers, a breakdown voltage of 3.3 kV, a peel strength of 5.2 N/cm, a thermal conductivity of 5.2 W/m*K, and excellent film formability. In the film, PAI resin: (epoxy resin+curing agent)=6:4 (weight ratio). The film had 86.2 wt % of aluminum nitride filler.

### Comparative Example 9

100 g of PAI resin B solution (solid content of 30%) from Synthesis Example 2, 10.79 g of the epoxy resin YX4000, 7.89 g of the epoxy resin CDMDG, 11.32 g of the curing agent MEH-7500, 200.77 g of the aluminum nitride filler AlN250RW, 20.08 g of the aluminum nitride filler AlN100NW, 180.69 g of the aluminum nitride filler AlNO20NW, and 4.14 g of the benzene-containing silane AP-S8010 were mixed to form a film having a thickness of 70 micrometers, a breakdown voltage of 2.1 kV, a peel strength of 5.2 N/cm, a thermal conductivity of 5.1 W/m*K, and excellent film formability. In the film, PAI resin: (epoxy resin+curing agent)=5:5 (weight ratio). The film had 86.2 wt % of aluminum nitride filler. As shown in Comparative Example 9, when the amount of the epoxy resin and the curing agent was too high, the breakdown voltage of the film would decrease.

### Comparative Example 10

100 g of PAI resin B solution (solid content of 30%) from Synthesis Example 2, 2.70 g of the epoxy resin YX4000, 1.97 g of the epoxy resin CDMDG, 2.83 g of the curing agent MEH-7500, 125.48 g of the aluminum nitride filler AlN250RW, 12.55 g of the aluminum nitride filler AlN100NW, 112.93 g of the aluminum nitride filler AlNO20NW, and 2.59 g of the benzene-containing silane AP-S8010 were mixed to form a film having a thickness of 75 micrometers, a breakdown voltage of 3.4 kV, a peel strength of 3.3 N/cm, a thermal conductivity of 4.1 W/m*K, and excellent film formability. In the film, PAI resin: (epoxy resin+curing agent)=8:2 (weight ratio). The film had 86.2 wt % of aluminum nitride filler. As shown in Comparative Example 10, when the amount of the epoxy resin and the curing agent was too low, the peel strength and the thermal conductivity of the film would decrease.

### Example 15

100 g of PAI resin B solution (solid content of 30%) from Synthesis Example 2, 4.08 g of the epoxy resin YX4000, 4.50 g of the epoxy resin YX8000, 4.28 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 72 micrometers, a breakdown voltage of 3.2 kV, a peel strength of 5.2 N/cm, a thermal conductivity of 5.3 W/m*K, and excellent film formability. In the film, PAI resin: (epoxy resin+curing agent)=7:3 (weight ratio). The film had 86.2 wt % of aluminum nitride filler.

### Example 16

100 g of PAI resin B solution (solid content of 30%) from Synthesis Example 2, 3.66 g of the epoxy resin YX4000, 2.67 g of the epoxy resin CDMDG, 6.53 g of the curing agent MEHC-7841-4S, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 73 micrometers, a breakdown voltage of 3.3 kV, a peel strength of 5.1 N/cm, a thermal conductivity of 5.5 W/m*K, and excellent film formability. In the film, PAI resin: (epoxy resin+curing agent)=7:3 (weight ratio). The film had 86.2 wt % of aluminum nitride filler.

### Example 17

100 g of PAI resin B solution (solid content of 30%) from Synthesis Example 2, 4.48 g of the epoxy resin YX4000, 3.27 g of the epoxy resin CDMDG, 5.10 g of the curing agent PF8090M62, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 70 micrometers, a breakdown voltage of 3.3 kV, a peel strength of 5.2 N/cm, a thermal conductivity of 5.6 W/m*K, and excellent film formability. In the film, PAI resin: (epoxy resin+curing agent)=7:3 (weight ratio). The film had 86.2 wt % of aluminum nitride filler.

### Comparative Example 11

9.30 g of the epoxy resin YX4000, 6.80 g of the epoxy resin CDMDG, 9.75 g of the curing agent MEH-7500, 86.50 g of the aluminum nitride filler AlN250RW, 8.65 g of the aluminum nitride filler AlN100NW, 77.85 g of the aluminum nitride fillerAlN020NW, and 1.78 g of the benzene-containing silane AP-S8010 were mixed to form a film having a thickness of 70 micrometers, a breakdown voltage of 1.2 kV, a peel strength of 5.3 N/cm, a thermal conductivity of 3.3 W/m*K, and excellent film formability. In the film, PAI resin: (epoxy resin+curing agent)=0:10 (weight ratio). The film had 86.2 wt % of aluminum nitride filler. As shown in Comparative Example 11, when the thermally conductive composition was free of PAI resin, the breakdown voltage of the film would be insufficient.

### Comparative Example 12

100 g of PAI resin B solution (solid content of 30%) from Synthesis Example 2, 100.38 g of the aluminum nitride filler AlN250RW, 10.04 g of the aluminum nitride filler AlN100NW, 90.35 g of the aluminum nitride filler AlNO20NW, and 2.07 g of the benzene-containing silane AP-S8010 were mixed to form a film having a thickness of 72 micrometers, a breakdown voltage of 3.4 kV, a peel strength of 0.8 N/cm, a thermal conductivity of 2.0 W/m*K, and excellent film formability. In the film, PAI resin: (epoxy resin+curing agent)=10:0 (weight ratio). The film had 86.2 wt % of aluminum nitride filler. As shown in Comparative Example 12, when the thermally conductive composition was free of the epoxy resin and the curing agent, the peel strength and the thermal conductivity of the film would be insufficient.

### Comparative Example 13

100 g of PAI resin L solution (solid content of 30%) from Synthesis Example 12, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 2.96 g of the benzene-containing silane AP-S8010 were mixed to form a film having a thickness of 70 micrometers, a breakdown voltage of 2.4 kV, a peel strength of 5.5 N/cm, a thermal conductivity of 2.3 W/m*K, and excellent film formability. In the film, PAI resin: (epoxy resin+curing agent)=7:3 (weight ratio). The film had 86.2 wt % of aluminum nitride filler. As shown in Comparative Example 13, when n number of PAI resin in the thermally conductive composition was too low, the breakdown voltage and the thermal conductivity of the film would be insufficient.

### Comparative Example 14

100 g of PAI resin M solution (solid content of 30%) from Synthesis Example 13, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.96 g of the benzene-containing silane AP-S8010 were mixed to form a film having a thickness of 70 micrometers, a breakdown voltage of 2.3 kV, a peel strength of 5.8 N/cm, a thermal conductivity of 2.7 W/m*K, and excellent film formability. In the film, PAI resin: (epoxy resin+curing agent)=7:3 (weight ratio). The film had 86.2 wt % of aluminum nitride filler. As shown in Comparative Example 14, when m number of PAI resin in the thermally conductive composition was too low, the breakdown voltage and the thermal conductivity of the film would be insufficient.

### Example 18

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlN020NW, and 5.69 g of the benzene-containing silane AP-S8010 were mixed to form a film having a thickness of 71 micrometers, a breakdown voltage of 3.2 kV, a peel strength of 5.0 N/cm, a thermal conductivity of 5.1 W/m*K, and excellent film formability. In the film, PAI resin: (epoxy resin+curing agent)=7:3 (weight ratio). The film had 86.2 wt % of aluminum nitride filler.

### Example 19

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 6.49 g of the benzene-containing silane SIP-6722.6 were mixed to form a film having a thickness of 70 micrometers, a breakdown voltage of 3.0 kV, a peel strength of 5.3 N/cm, a thermal conductivity of 5.3 W/m*K, and excellent film formability. In the film, PAI resin: (epoxy resin+curing agent)=7:3 (weight ratio). The film had 86.2 wt % of aluminum nitride filler.

### Comparative Example 15

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 2.27 g of the benzene-containing silane AP-S8010 were mixed to form a film having a thickness of 72 micrometers, a breakdown voltage of 1.8 kV, a peel strength of 2.3 N/cm, and a thermal conductivity of 3.5 W/m*K. Although the thermally conductive composition could be used to form a film, filler aggregation phenomena were present on the film surface. In the film, PAI resin: (epoxy resin+curing agent)=7:3 (weight ratio). The film had 86.2 wt % of aluminum nitride filler. As shown in Comparative Example 15, when the amount of the benzene-containing silane was too low, the filler could not be efficiently dispersed in the thermally conductive composition due to the aggregation phenomenon.

### Comparative Example 16

100 g of PAI resin B solution (solid content of 30%) from Synthesis Example 2, 4.63 g of the epoxy resin YX4000, 3.38 g of the epoxy resin CDMDG, 4.85 g of the curing agent MEH-7500, 143.41 g of the aluminum nitride filler AlN250RW, 14.34 g of the aluminum nitride filler AlN100NW, 129.07 g of the aluminum nitride filler AlNO20NW, and 7.14 g of the benzene-containing silane SIP-6722.6 were mixed to form a film having a thickness of 72 micrometers, a breakdown voltage of 2.3 kV, a peel strength of 2.2 N/cm, and a thermal conductivity of 2.8 W/m*K. Although the thermally conductive composition could be used to form a film, filler aggregation phenomenawere present on the film surface. In the film, PAI resin: (epoxy resin+curing agent)=7:3 (weight ratio). The film had 86.2 wt % of aluminum nitride filler. As shown in Comparative Example 16, when the amount of the benzene-containing silane was too high, the filler would self-aggregate to degrade the film surface or even result in insufficient film formability.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A thermally conductive composition, comprising:
(A) polyamide-imide, (B) epoxy resin, (C) curing agent, (D) filler, and (E) benzene-containing silane, wherein (A) polyamide-imide has a chemical structure of 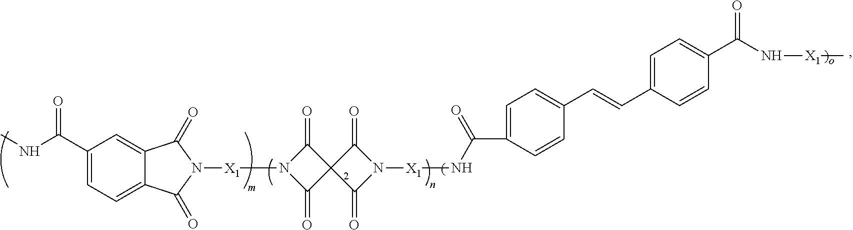
wherein X₁ is 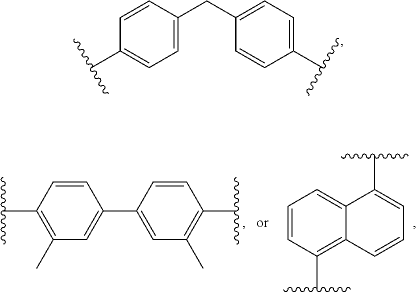 [SMILES: *c1ccc(Cc2ccc(*)cc2)cc1 ; *c1ccc(-c2ccc(*)c(C)c2)cc1C ; *c1cccc2c(*)cccc12]
X₂ is 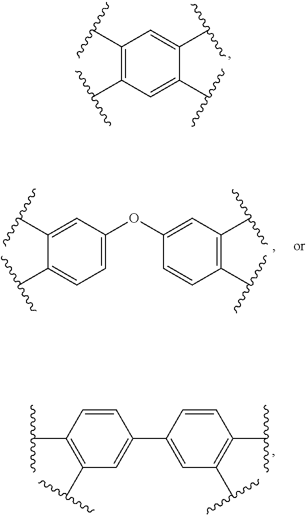 [SMILES: *c1cc(*)c(*)cc1* ; *c1ccc(Oc2ccc(*)c(*)c2)cc1* ; *c1ccc(-c2ccc(*)c(*)c2)cc1*]
m=60 to 80, n=10 to 30, and o=10 to 30.

2. The thermally conductive composition as claimed in claim 1, wherein a weight of (A) polyamide-imide and a total weight of (B) epoxy resin and (C) curing agent have a ratio of 6:4 to 7:3.

3. The thermally conductive composition as claimed in claim 1, wherein (B) 17 epoxy resin and (C) curing agent have a weight ratio of 1:0.5 to 1:1.1.

4. The thermally conductive composition as claimed in claim 1, wherein the thermally conductive composition and (D) filler have a weight ratio of 100:84 to 100:89.

5. The thermally conductive composition as claimed in claim 1, wherein (D) filler and (E) benzene-containing silane have a weight ratio of 100:1 to 100:2.3.

6. The thermally conductive composition as claimed in claim 1, wherein (B) epoxy resin comprises 4,4′-bis(2,3-epoxypropoxy)-3,3′,5,5′-tetramethylbiphenyl, hydrogenated bisphenol A resin, 1,4-cyclohexanedimethanol diglycidyl ether, or a combination thereof.

7. The thermally conductive composition as claimed in claim 1, wherein (C) curing agent comprises triphenylmethane-type phenolic resin, xylene-modified phenolic resin, biphenyl-type phenolic resin, or a combination thereof.

8. The thermally conductive composition as claimed in claim 1, wherein (D) filler comprises aluminum nitride filler.

9. The thermally conductive composition as claimed in claim 8, wherein the aluminum nitride filler comprises (D1) aluminum nitride filler having a diameter of 1 micrometer to 3 micrometers, (D2) aluminum nitride filler having a diameter of 5 micrometers to 15 micrometers, and (D3) aluminum nitride filler having a diameter of 20 micrometers to 30 micrometers.

10. The thermally conductive composition as claimed in claim 9, wherein (D1) aluminum nitride filler having a diameter of 1 micrometer to 3 micrometers, (D2) aluminum nitride filler having a diameter of 5 micrometers to 15 micrometers, and (D3) aluminum nitride filler having a diameter of 20 micrometers to 30 micrometers have a weight ratio of 50˜70:5˜10:20˜45.

11. The thermally conductive composition as claimed in claim 1, wherein (E) benzene-containing silane comprises trimethoxyphenylsilane, trimethoxy(2-phenylethyl)silane, or a combination thereof.
